(19) United States
(12) Patent Application Publication
(10) Pub. No.: US 2011/0262875 A1
(43) Pub. Date: Oct. 27, 2011

(54) Thermo-sensing color-changeable candle

(76) Inventor: Jen-Meng Lin, Gueiren Township (TW)

(21) Appl. No.: 12/799,406

(22) Filed: Apr. 26, 2010

(51) Int. Cl. F23D 3/16; C11C 5/00

(52) U.S. Cl. 431/289

(57) ABSTRACT

A thermo-sensing color-changeable candle includes a candle and thermo-sensing powder combined together. The thermo-sensing powder will change colors and the decorative patterns concealed at the bottom of the candle beforehand will be revealed when the candle is burnt and the temperature of the candle rises.

### BACKGROUND OF THE INVENTION

1. Field of the Invention

This invention relates to a thermo-sensing color-changeable candle, particularly to one combined with thermo-sensing powder that can change colors when the candle is burnt and its temperature rises, able to enhance integral variability and practicability of the candle

2. Description of the Prior Art

Most candles commonly seen are only changed in shapes with a monotonous function of burning and lighting.

### SUMMARY OF THE INVENTION

The objective of this invention is to offer a thermo-sensing color-changeable candle combined with thermo-sensing powder that can produce different colors when the candle is burnt with its temperature rising.

The candle in the present invention includes a candle and thermo-sensing powder. The candle is provided in the interior with a candlewick and a plurality of decorative patterns. The thermo-sensing powder is combined with the candle, changing its color to become transparent and enabling the hidden patterns at the bottom of the candle visible in case of the candle burned.

### BRIEF DESCRIPTION OF DRAWINGS

This invention will be better understood by referring to the accompanying drawings, wherein:

FIG. 1 is an exploded perspective view of a first preferred embodiment of a thermo-sensing color-changeable candle in the present invention;

FIG. 2 is a perspective view of the first preferred embodiment of the thermo-sensing color-changeable candle in the present invention;

FIG. 3 is a schematic view of the first preferred embodiment of the thermo-sensing color-changeable candle in use in the present invention;

FIG. 4 is a perspective view of a second preferred embodiment of a thermo-sensing color-changeable candle in the present invention; and

FIG. 5 is a schematic view of the second preferred embodiment of the thermo-sensing color-changeable candle in use in the present invention.

### DETAILED DESCRIPTION OF THE PREFERRED EMBODIMENT

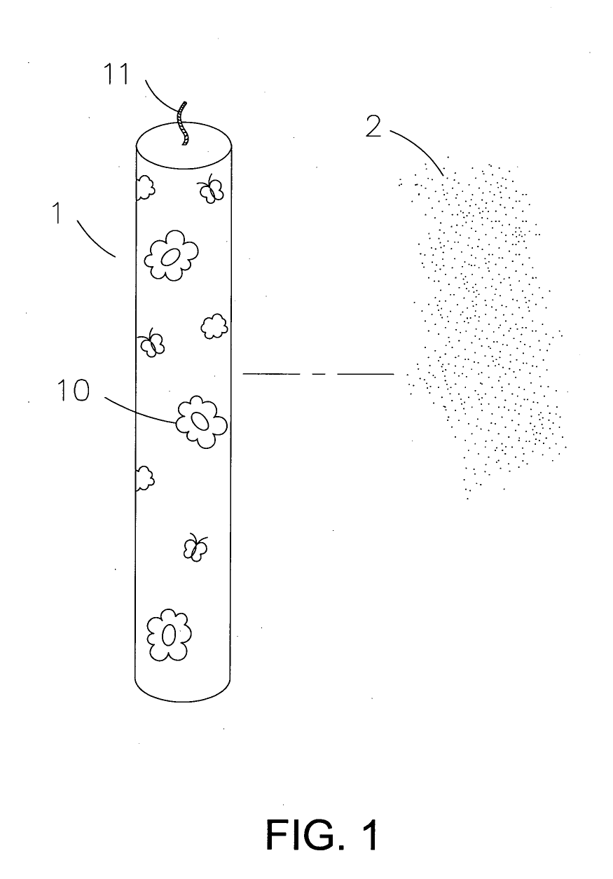

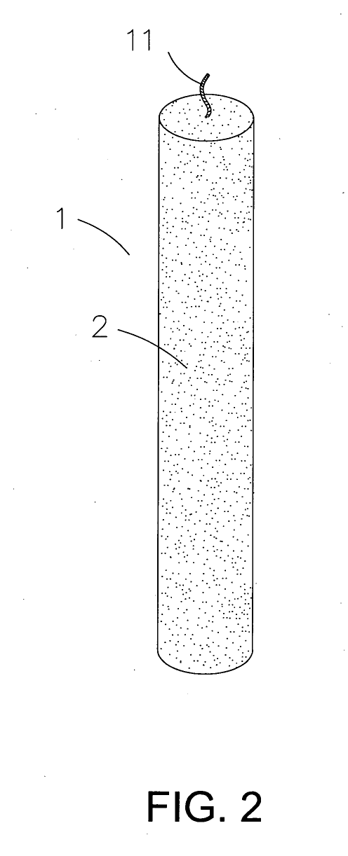

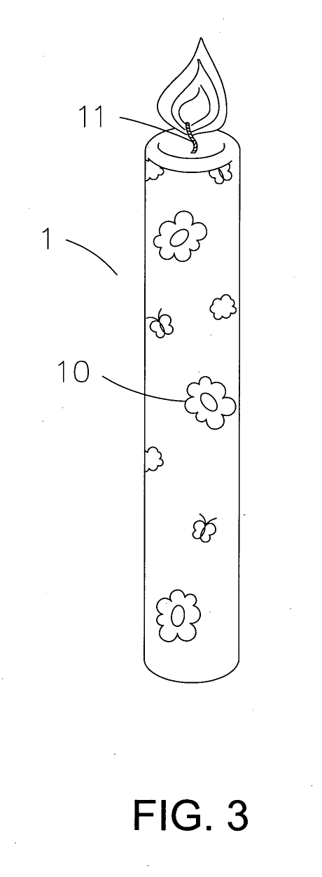

A first preferred embodiment of a thermo-sensing color-changeable candle in the present invention, as shown in FIGS. 1, 2 and 3, includes a candle 1 and thermo-sensing powder 2 combined together.

The candle 1 is provided with lots of decorative patterns 10 (or characters) concealed in the interior in advance and a candlewick 11.

The thermo-sensing powder 2 is combined with the candle 1 by way of spraying or other processing modes.

In using, when the candlewick 11 of the candle 1 is lighted and the temperature of burning portion of the candle 1 rises, the thermo-sensing powder 2 will change colors to become transparent and the decorative patterns 10 concealed at the bottom of the thermo-sensing powder 2 will be visible clearly, achieving effects of novelty, variability and sense of mystery.

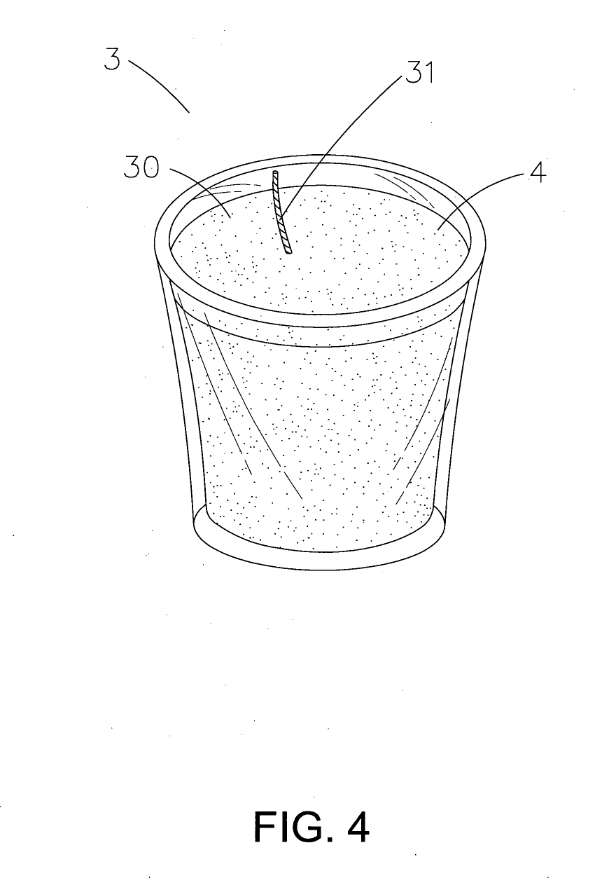

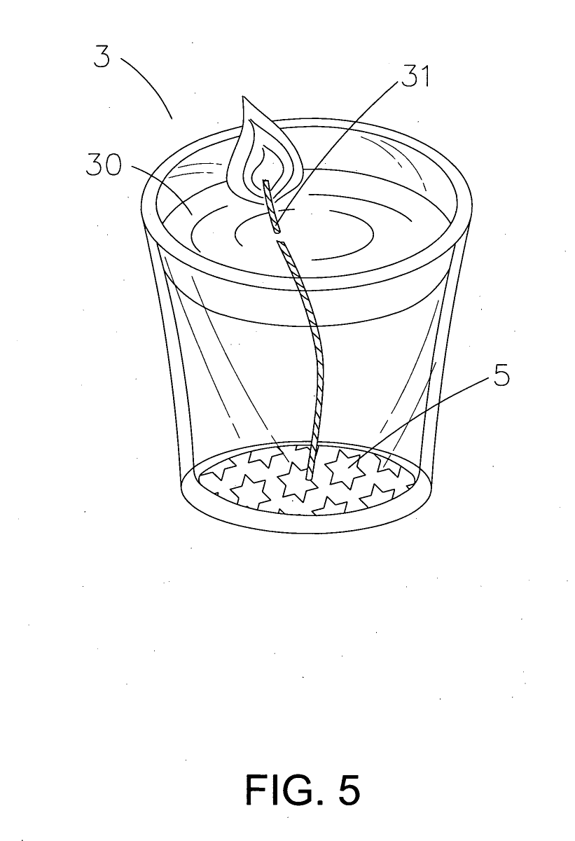

A second preferred embodiment of a thermo-sensing color-changeable candle in the present invention, as shown in FIGS. 4 and 5, includes a candle 3, thermo-sensing powder 4 and decorative patterns 5 combined together.

The candle 3 is composed of transparent jellified wax and a candlewick 31. The thermo-sensing powder 4 is dissolved in and mixed with the transparent jellified wax 30, letting the candle 3 become opaque under normal temperature. The decorative patterns 5, which can be trademarks geometric figures or characters, are positioned at the bottom of the candle 3.

In using, when the candlewick 31 of the candle 3 is lighted, the thermo-sensing powder 4 on the candle 3 will change colors and become transparent and meanwhile, the transparent jellified wax 30 will also become transparent to let the decorative patterns 5 at the bottom of the candle 3 visible clearly, attaining special effects of novelty and variability.

As can be understood from the above description, the preferred embodiments of this invention have the following advantages.

1. The whole value of the thermo-sensing color-changeable candle 1 can greatly be elevated.

2. The thermo-sensing color-changeable candle 1 can be used with comparatively great variability.

3. The thermo-sensing color-changeable candle 3 is provided with the decorative patterns 5, such as advertising patterns, which are concealed in advance at the bottom of the thermo-sensing powder 4, offering a unique and novel advertising effect for clients.

While the preferred embodiments of the invention have been described above, it will be recognized and understood that various modifications may be made therein and the appended claims are intended to cover all such modifications that may fall within the spirit and scope of the invention.

What is claimed is:

1. A thermo-sensing color-changeable candle comprising:
a candle provided with a candlewick and plurality of decorative patterns in an interior;
thermo-sensing powder combined together with said candle, said thermo-sensing powder covering and concealing said decorative patterns of said candle; and
said thermo-sensing powder changing colors to become transparent and said decorative patterns concealed at the bottom of said thermo-sensing powder becoming visible clearly when said candle is lighted and the temperature of burning portion of said candle rises, thus achieving effects of novelty, variability and sense of mystery.

2. A thermo-sensing color-changeable candle comprising:
a candle composed of a transparent jellified-wax and a candlewick;
thermo-sensing powder combined with said transparent jellified-wax;
decorative patterns positioned at the bottom of said candle, said decorative patterns being figures or characters; and
said candle changing colors to become transparent and revealing said decorative patterns when said candle is lit and the temperature of said candle rises.
